(19) United States
(12) Patent Application Publication
(10) Pub. No.: US 2025/0338110 A1
(43) Pub. Date: Oct. 30, 2025

(54) SELF-ONBOARDING FOR PRIVATE CELLULAR NETWORKS

(71) Applicant: Insight Direct USA, Inc., Chandler, AZ (US)

(72) Inventors: Marc Brumfield, Lemont, IL (US); Douglas Gatto, Bonita, CA (US); Martin Sanchez, Heath, TX (US)

(21) Appl. No.: 19/189,682

(22) Filed: Apr. 25, 2025

Related U.S. Application Data
(60) Provisional application No. 63/638,580, filed on Apr. 25, 2024.

(51) Int. Cl. H04W 8/18; H04B 1/7163; H04W 8/20; H04W 8/26; H04W 76/15

(52) U.S. Cl. CPC H04W 8/183; H04B 1/7163; H04W 8/20; H04W 8/265; H04W 76/15

(57) ABSTRACT

A method of self-onboarding of a wireless device to a private cellular network includes detecting an ultra-wideband base station of an ultra-wideband network, the ultra-wideband network connected to a SIM broker, connecting the wireless device to the ultra-wideband base station in response to detecting the ultra-wideband base station, transmitting a request to connect to a private cellular network to the ultra-wideband base station, and receiving a SIM configuration generated by the SIM broker. The request to connect to the private cellular network is transmitted by the wireless device, a destination of the request is the SIM broker, and the SIM configuration is received from the ultra-wideband base station. The method further includes installing the SIM configuration to an eSIM of the wireless device and establishing a connection between the wireless device and the private cellular network using the installed eSIM configuration.

### CROSS-REFERENCE TO RELATED APPLICATION

This application is a nonprovisional application claiming the benefit of U.S. provisional Ser. No. 63/638,580, filed on Apr. 25, 2024, and entitled “SELF-ONBOARDING FOR PRIVATE CELLULAR NETWORKS.”

### FIELD OF THE INVENTION

The present disclosure relates to private cellular networks and, more particularly, systems and methods for device self-onboarding to private cellular networks.

### BACKGROUND

Private cellular networks provide dedicated wireless coverage to a particular geographic area and can be used to provide internet access or other connectivity to devices connected thereto. Private cellular networks have improved coverage as compared to other wireless networking solutions and, accordingly, can be particularly useful for organizations and businesses having large geographic footprints.

### SUMMARY

An example of a method of onboarding devices to a private cellular network includes receiving device identity information for a user device to be connected to the private cellular network, receiving a request from the user device to connect to the private cellular network, and transmitting the request to a subscriber identity module (SIM) broker. An ultra-wideband base station receives the device identity information, receives the request form the user device, and transmits the request. The method further includes, by the SIM broker, generating a new electronic subscriber identity module (eSIM) configuration for the user device based on the device identity information and transmitting the new eSIM configuration to the ultra-wideband base station. The new eSIM configuration is then transmitted to the user device by the ultra-wideband base station. The method yet further includes, by the user device, installing the eSIM configuration to an eSIM of the user device and initiating a connection between the user device and the private cellular network using the installed eSIM configuration.

An example of a method of self-onboarding of a wireless device to a private cellular network includes detecting an ultra-wideband base station of an ultra-wideband network, the ultra-wideband network connected to a SIM broker, connecting the wireless device to the ultra-wideband base station in response to detecting the ultra-wideband base station, transmitting a request to connect to a private cellular network to the ultra-wideband base station, and receiving a SIM configuration generated by the SIM broker. The request to connect to the private cellular network is transmitted by the wireless device, a destination of the request is the SIM broker, and the SIM configuration is received from the ultra-wideband base station. The method further includes installing the SIM configuration to an eSIM of the wireless device and establishing a connection between the wireless device and the private cellular network using the installed eSIM configuration.

An example of a system for automated device onboarding to a private cellular network includes a base station of an ultra-wideband network, a base station of the private cellular network, and a SIM broker. The SIM broker comprises a first processor and at least one first memory encoded with first instructions. When executed, the first instructions cause the first processor to receive a request to connect to the private cellular network and generate a SIM configuration in response to the request. The system further includes a wireless device comprising an electronic subscriber identity module (eSIM), a second processor, and at least one second memory. The at least one second memory encoded with second instructions that, when executed, cause the second processor to establish a first connection with the base station of the ultra-wideband connection and transmit the request to connect to the private cellular network to the ultra-wideband network. A destination of the request is the SIM broker. The second instructions, when executed, further cause the second processor to receive the SIM configuration from the SIM broker via the first connection, install the SIM configuration to the eSIM, and establish a second connection with the base station of the private cellular network using the installed SIM configuration.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a schematic view of an example of a system for device self-onboarding to a private cellular network.

FIG. 2 is a schematic view of an example of a real-time location system based on an ultra-wideband network suitable for use with the system of FIG. 1.

FIG. 3 is a schematic view of a further example of a system for device self-onboarding to a private cellular network.

FIG. 4 is a flow diagram of an example of a method of self-onboarding to a private cellular network suitable for use with the system of FIG. 1.

FIG. 5 is a flow diagram of a further example of a method of self-onboarding to a private cellular network suitable for use with the system of FIG. 1.

While the above-identified figures set forth one or more examples of the present disclosure, other examples are also contemplated, as noted in the discussion. In all cases, this disclosure presents the invention by way of representation and not limitation. It should be understood that numerous other modifications and examples can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

The present description relates to systems and methods for device self-onboarding to private cellular networks (PCNs). As referred to herein, a “private cellular network” refers to a mobile or cellular network operated by a private host or operator. As referred to herein, the terms “private network host,” “private host,” and “private network operator” refer to an entity or individual other than a carrier network operator such as a communication service provider (CSP), a mobile service provider (MSP), a mobile network operator (MNO), mobile virtual network operator (MVNO) a cellular company, a mobile network carrier, or a wireless service provider (WSP), among other options.

As will be explained in more detail subsequently, the systems and methods described herein enable automatic generation of subscriber identity module (SIM) configuration information for authenticating to and connecting to a private cellular network as well as automated self-onboarding to the private cellular network by the device. In particular, systems and methods disclosed herein enable onboarding of a wireless device to a private cellular network using a connection to an ultra-wideband network. As will be explained in more detail subsequently, a wireless device (e.g., a consumer cellphone) can sense and detect an ultra-wideband network that has at least partially overlapping range with a private cellular network. The wireless device can then connect to the ultra-wideband network to retrieve a SIM profile for the private cellular network and, subsequently, use the new SIM configuration to connect to the private cellular network. Further, the systems and methods described herein present several options for access control to local network components and external network connections (e.g., local network components, the Internet, etc.) for devices connected to the private cellular network, as well as for tracking device position (and thereby, inferred user position) using the same UWB network used for device onboarding.

The self-onboarding and access control provided by the systems and methods described herein can be used by businesses and other private cellular network operators to, for example, allow guests and other visitors to connect to a private cellular network and to access external networks, such as the Internet, via the private cellular network. As private cellular networks have significantly more range than Wi-Fi networks or other types of mobile networks commonly used to provide guest internet access and, as such, require fewer base stations and provide improvements to coverage and service as compared to those shorter range wireless networks.

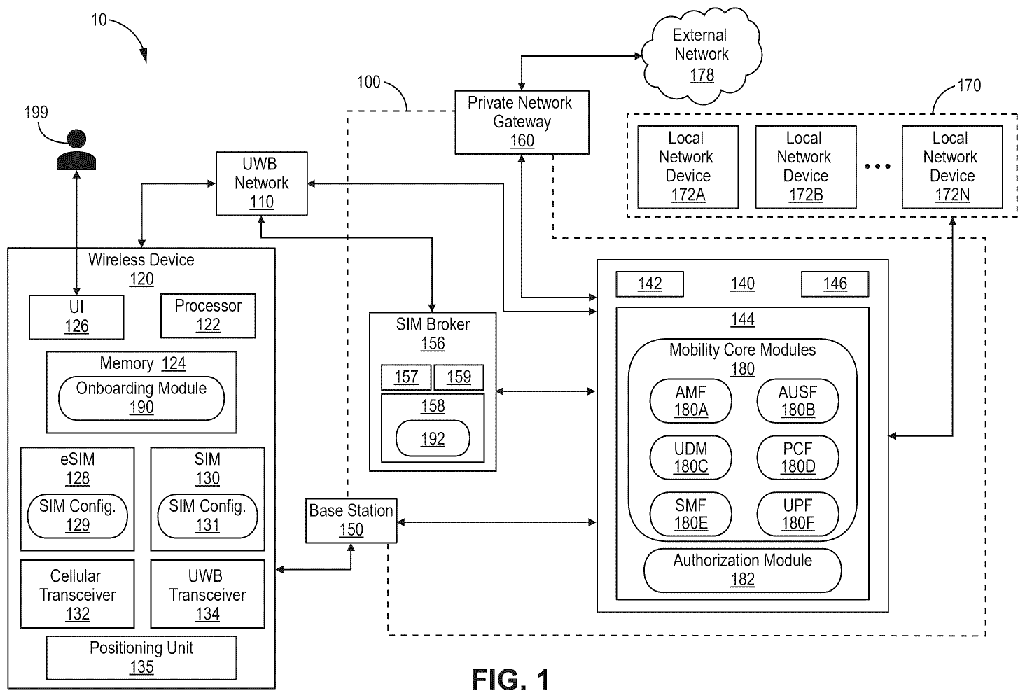

FIG. 1 is a schematic diagram of system 10, which is a system for automated device onboarding to a private cellular network. System 10 includes private cellular network 100, UWB network 110, and wireless device 120. Private cellular network 100 includes server 140, cellular base station 150, SIM broker 156, and private network gateway 160. Wireless device 120 includes processor 122, memory 124, user interface 126, electronic subscriber identity module (eSIM) 128, SIM 130, cellular transceiver 132, UWB transceiver 134, and positioning unit 135. Server 140 includes processor 142, memory 144, and interface 146. SIM Broker 156 includes processor 157, memory 158, and interface 159. Memory 144 stores mobility core modules 180 and authorization module 182. Mobility core modules 180 are comprised of optional software modules for enabling various functionality of private cellular network 100, including access and mobility management function (AMF) module 180A, authentication server function (AUSF) module 180B, unified data management (UDM) module 180C, policy control function (PCF) module 180D, session management function (SMF) module 180E, and user plane function (UPF) module 180F. Memory 124 includes onboarding module 190. eSIM 128 includes SIM configuration 129 and SIM 130 includes SIM configuration 131. FIG. 1 also depicts local network 170, which includes local network devices 172A-170N, as well as external network 178 and user 199. The boundaries of private cellular network 100 and local network 170 are delineated with dotted lines in FIG. 1 and can be modified relative to the embodiment depicted in FIG. 1, as discussed in detail subsequently.

Private cellular network 100 is a wireless network operated by a private host or network operator. Private cellular network 100 can be referred to as a “neutral host mobile network” in some examples where network equipment of private cellular network 100 is leased to or otherwise used by an operator of a carrier network (e.g., a CSP). In yet further examples, private cellular network 100 can be referred to as a “private mobile network.” Server 140, base station 150, SIM broker 156, private network gateway 160, and local network components 170 are referred to herein as “network devices” of private cellular network 100. As will be explained in more detail subsequently, server 140, base station 150, SIM broker 156, and private network gateway 160 enable guest devices (e.g., wireless devices 180A-N) to connect to and self-onboard to private cellular network 100 and, subsequently, to access one or more of MNO networks 194A-N and/or external network 178 via electromagnetic signals exchanged with base station 150. Private cellular network 100 is a cellular network and, in some examples, is a radio access network, a fifth generation (5G) cellular network, a fourth generation (4G) cellular network, a long term evolution (LTE) network, a millimeter wave (MMW) network, any other suitable type of cellular network, or any combination thereof. In at least some examples, private cellular network 100 is a citizens broadband radio service (CBRS) network. Private cellular network can broadcast at any frequency range suitable for providing cellular service. In at least some examples, private cellular network 100 operates within the 3.55 GHz to 3.7 GHz CBRS range.

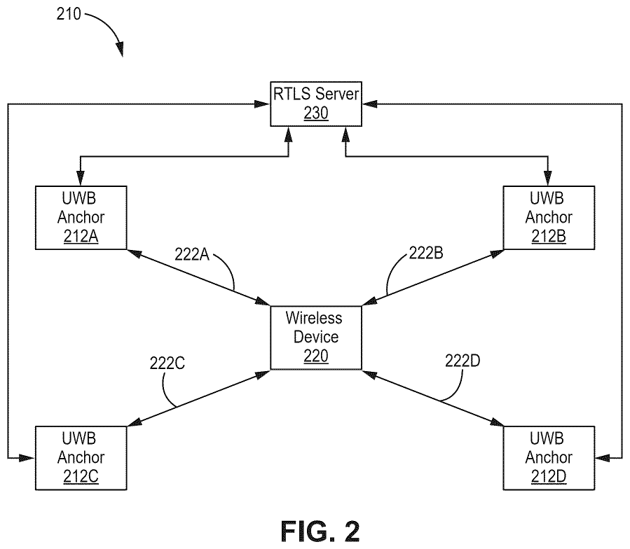

UWB network 110 is an ultra-wideband network that is at least partially co-spatial with the broadcast area of private cellular network 100, such that the geographic extent of the broadcast area of UWB network 110 at least partially overlaps with the geographic extent of the broadcast area of private cellular network 100. As will be explained in more detail subsequently and particularly with respect to the discussion of FIG. 2, UWB network 110 can include any suitable number of base stations and, further, can be used both for data transmission and as a real-time location system (RTLS). In particular, UWB network 110 can be used to push SIM configuration 129 to wireless device 120 and, subsequently, to track the position of wireless device 120 throughout the area of UWB network 110. The base stations of UWB network 110 can be positioned in any suitable pattern or configuration, and can be arranged to have any suitable antenna separation distance between base stations. UWB network 110 can broadcast in any suitable frequency range. In at least some examples, UWB network broadcasts in a frequency range suitable for RTLS services, such as in the frequency range of between 3.1 GHz and 10.6 GHz. The base stations of UWB network 110 can be referred to in some examples as “anchors” and/or “beacons.” In some examples, devices tracked using UWB network 110 can be referred to as “probes.”

Wireless device 120 is a user wireless device that a user, such as user 199, can use to connect to private cellular network 100 and/or UWB network 110. Wireless device 120 can, in some examples, be referred to as a “user device” or as “user equipment.” As will be explained in more detail subsequently, system 10 enables wireless device 120 to but automatedly onboarded to private cellular network 100.

Processor 122 of wireless device 120 can execute software, applications, and/or programs stored on memory 114. Examples of processor 122 can include one or more of a processor, a microprocessor, a controller, a digital signal processor (DSP), an application specific integrated circuit (ASIC), a field-programmable gate array (FPGA), or other equivalent discrete or integrated logic circuitry. Processor 122 can be entirely or partially mounted on one or more circuit boards.

Memory 124 of wireless device 120 is configured to store information and, in some examples, can be described as a computer-readable storage medium. Memory 124, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 124 is a temporary memory. As used herein, a temporary memory refers to a memory having a primary purpose that is not long-term storage. Memory 124, in some examples, is described as volatile memory. As used herein, a volatile memory refers to a memory that does not maintain stored contents when power to the memory is turned off. Examples of volatile memories can include random access memories (RAM), dynamic random access memories (DRAM), static random access memories (SRAM), and other forms of volatile memories. In some examples, the memory is used to store program instructions for execution by the processor. Memory 124, in one example, is used by software or applications running on wireless device 120 to temporarily store information during program execution.

Memory 124, in some examples, also includes one or more computer-readable storage media. The storage media can be configured to store larger amounts of information than volatile memory and, further, can be configured for long-term storage of information. In some examples, memory 124 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories.

User interface 126 is an input and/or output device and/or software interface of wireless device 120, and enables control, operation of, and/or interaction with software elements of wireless device 120 by an operator and/or by other devices connected to user wireless device 120. For example, user interface 126 can be configured to receive inputs from an operator and/or provide outputs. Interface 116 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines. In some examples, user interface 126 can also include one or more software interfaces for enabling access and use of the programs of wireless device 120, such as one or more application programming interfaces (APIs) and/or one or more software network interfaces, among other options.

eSIM 128 is an electronic subscriber identity module and includes one or more hardware and/or software elements for storing and managing SIM configuration 129. eSIM 128 can include any suitable hardware, including a removable or embedded (e.g., physically soldered) hardware device. In yet further examples, eSIM 128 can be a software SIM. As will be explained in more detail subsequently, SIM configuration 129 can be automatedly installed to eSIM 128 via, e.g., UWB network 110. eSIM 128 generally includes an embedded universal integrated circuit card (eUICC) or an equivalent software to enable installation of SIM configurations via transmissions from UWB network 110 or another suitable non-cellular network, such as a Wi-Fi network.

SIM configuration 129 is an operational profile that enables wireless device 120 to access private cellular network 100. SIM configuration 129 contains authentication information or equivalent information that can be used by wireless device 120 to connect to wireless network 110. as will be explained in more detail subsequently. In some examples, SIM configuration 129 can be referred to as a “network profile” or a “SIM profile.”

SIM 130 is another subscriber identity module and includes one or more hardware and/or software elements for managing SIM configuration 131. SIM 130 and SIM configuration 131 are optional elements of wireless device 120. SIM 130 can include any suitable hardware, including removable or embeddable hardware elements. SIM 130 can be, in some examples, an eSIM and can include an eUICC or other suitable software for managing SIM configuration 131.

SIM configuration 131 is an operational profile that enables wireless device 120 to connect to an access a cellular network other than private cellular network 100 and includes information for authenticating access to that cellular network. The other cellular network can be any suitable cellular network and, in some examples, is a network offered by a mobile network operator (MNO).

As described previously, both SIM 130 and SIM configuration 131 are optional elements of wireless device 120, and in at least some examples, wireless device 120 lacks both SIM 130 and SIM configuration 131. In further examples, wireless device 120 only includes eSIM 128 (i.e., wireless device 120 lacks SIM 130) but includes both SIM configuration 129 and SIM configuration 131. In these examples, SIM configuration 129 and SIM configuration 131 are different profiles managed by eSIM 128. In yet further examples, wireless device 120 can include more than two SIM components and/or SIM configurations.

Cellular transceiver 132 can transmit signals to and receive signals from cellular networks, such as private cellular network 100. UWB transceiver 134 can transmit signals to and receive signals from ultra-wideband networks, such as UWB network 110. Cellular transceiver 132 and UWB transceiver 134 can be connected to one or more antennae to capture and transmit (e.g., by radiation) UWB and cellular radio signals. Wireless device 120 can include separate antennas for each of cellular transceiver 132 and UWB transceiver 134, or can both cellular transceiver 132 and UWB transceiver 134 can use one or more shared antennas.

Positioning unit 135 can receive signals from one or more navigation broadcast devices to determine the approximate location of wireless device 120. Positioning unit 135 can be, for example, a global positioning system (GPS) unit, a global navigation satellite system (GNSS) unit, or any other suitable unit for generating position information for wireless device 120. Positioning unit 135 can generate position data for wireless device 120 using any suitable method and based on signals received from one or more navigation broadcast devices. The navigation broadcast devices can be, for example, geopositioning satellites. Positioning unit 135 can include a separate antenna for receiving geopositioning signals or can use one or more shared antennas (i.e., shared with cellular transceiver 132, UWB transceiver 134, etc.).

Server 140 is a network component or network device of private cellular network 100 and includes software for authenticating and authorizing users of private cellular network 100, as well as software for performing basic mobile network functions, such as basic or core functions of the protocol operated by private cellular network 100 (e.g., 5G, 4G, LTE, etc.). Server 140 is connected to base station 150, SIM broker 156, private network gateway 160, and local network 170, and in some examples performs routing, switching, packet forwarding, or any combination of the foregoing functions. In some examples, server 140 is also connected to UWB network 110. In some of these examples, server 140 can direct traffic from UWB network 110 to SIM broker 156, and from SIM broker 156 to UWB network 110.

Processor 142, memory 144, and interface 146 are substantially similar to each of processor 122, memory 124, and user interface 126, respectively, and the descriptions of processor 122, memory 124, and user interface 126 herein are applicable to processor 142, memory 144, and interface 146, respectively.

Base station 150 is a receiver and transmitter of private cellular network 100, and functions as a wireless access point of private cellular network 100. One or more wireless devices, such as wireless device 120, can connect to base station 150 to access connectivity and other functionality of private cellular network 100. Base station 150 is configured to send and receive electromagnetic signals representative of data. In some examples, base station 150 is configured to send and receive electromagnetic signals representative of one or more packets. Base station 150 is also configured to send electronic signals representative of data (e.g., as one or more network packets) to other devices of private cellular network 100, such as server 140 or SIM broker 156. Base station 150 can then forward the received data to another network device of private cellular network 100 by transmitting electronic signals representative of the data (e.g., as one or more packets). Base station 150 can also receive electronic signals representative of data (e.g., as one or more packets) from another network device and transmit or broadcast electromagnetic signals representative of that received data (e.g., as one or more packets) to a wireless device (e.g., one of wireless devices 180A-N, bridge 184, etc.). Base station 150 can be configured to transmit, broadcast, receive, etc. electromagnetic signals of any suitable wavelength or within any suitable range or spectrum of wavelengths. In at least some examples, base station 150 is configured to transmit, broadcast, receive, etc. signals within a wavelength of, for example, the 5G spectrum, the 4G spectrum, the LTE spectrum, the CBRS spectrum, etc.

SIM broker 156 is an electronic device of private cellular network 100, and is configured to generate and/or assign SIM configurations for devices connecting to private cellular network 100. SIM broker 156 is able to generate and/or assign SIM configurations based on device identity information, such as international mobile equipment identity (IMEI) information. SIM broker 156 can generate new SIM configurations and/or can assign a pre-generated SIM configuration to a given device. The SIM configurations generated and/or assigned by SIM broker 156 can be pushed to user equipment (e.g., wireless device 120) via UWB network 110 and, more particularly, can be pushed to an eSIM of user equipment (e.g., eSIM 128 of wireless device 120) to enable that user equipment to authenticate to private cellular network 100. SIM broker 156 includes processor 157, memory 158, and interface 159. Processor 157 is substantially similar to processors 122, 142, memory 158 is substantially similar to memories 124, 144, and interface 159 is substantially similar to user interface 126 and interface 146. Memory 158 including SIM generation module 192, which enables SIM broker to generate SIM configurations. Memory 158 can also store information that can be used to authenticate a wireless device requesting to connect to private cellular network 100.

As depicted in FIG. 1, SIM broker 156 can be connected to both UWB network 110 and server 140 in FIG. 1. Where SIM broker 156 is connected to one or more network components of UWB network 110, wireless device 120 can connect to UWB network 110 and the network components of UWB network 110 and/or network components connecting UWB network 110 to private cellular network 100 can direct requests from wireless device 120 for SIM configuration 129 to SIM broker 156. Additionally and/or alternatively, SIM broker 156 can be connected to server 140, and server 140 can route or otherwise forward requests from wireless device 120 for SIM configuration 129 to SIM broker 156. While SIM broker 156 is depicted as connected to both UWB network 110 and server 140 in FIG. 1, in other examples, SIM broker 156 is only connected to one of UWB network 110 and server 140.

Private network gateway 160 is a network device of private cellular network 100 that enables server 140 and other devices connected to private cellular network 100 to access external devices and networks, such as external network 178. Private network gateway 160 can include one or more hardware components can, in some examples, can include one or more protocol translators, impedance matching devices, rate converters, fault isolators, signal translators, and/or any other hardware and/or software element for providing interoperability between private cellular network 100 and other networks. FIG. 1 depicts a single private network gateway 160 in FIG. 1 for clarity and explanatory convenience, but in other examples, the functionality of private network gateway 160 can be distributed across multiple physical devices (e.g., with one or more dedicated physical devices for each external connections) and/or across multiple virtual devices distributed across any suitable number of hardware devices.

Local network 170 is local network that is connected to and accessible via private cellular network 100. Each of local network devices 172A-N can include any suitable network components for, e.g., storing data, operating one or more software applications, facilitating electronic communication to other local network components, etc. For explanatory clarity, local network 170 is depicted in FIG. 1 as connected to server 140. However, local network 170 can be connected to any device(s) of private cellular network 100 in any suitable manner or configuration. Further, local network 170 can be interconnected to each other in any suitable manner and each of local network components 170 can have any suitable connectivity to other local network components and/or other components of private cellular network 100. For convenience, FIG. 1 depicts local network 170 as including three local devices 172A-N, but in other examples, local network 170 can include a different number of local devices and/or any number of any other suitable network components.

External network 178 is an electronic communication network connected and external to private cellular network 100. External network 178 can include one or more wide area networks suitable for connecting servers and other computing devices external to private cellular network 100 and can include network infrastructure for connecting any suitable number of network or networking-capable devices. In at least some examples, external network 178 is or includes the Internet. Private network gateway 160 is depicted as connected to a single external network 178 in FIG. 1 for explanatory convenience and clarity, but in other examples, private network gateway 160 can be connected to any suitable number of external networks each of any suitable size and having any suitable number of devices.

Mobility core modules 180 include one or more software modules for operating private cellular network 100. In the depicted example, mobility core modules 180 can include one or more of AMF 180A, AUSF 180B, UDM 180C, PCF 180D, SMF 180E, and UPF 180F to operate a 5G network. However, in other examples where private cellular network 100 broadcasts and receives electromagnetic signals using a different telecommunications standard, mobility core modules 180 can include submodules appropriate for that telecommunications standard. For example, if private cellular network 100 is a 4G or LTE network, mobility core modules 180 can include submodules for a 4G or LTE network, respectively. In some examples, private cellular network 100 can broadcast and receive electromagnetic signals using multiple telecommunication standards. For example, private cellular network 100 can be configured to include both 5G and LTE components, such that private cellular network 100 can communicate with user equipment according to both the 5G and LTE standards, thereby allowing a larger pool of user devices to connect to private cellular network 100.

Authorization module 182 is a software module of server 140 and includes one or more programs for authorizing devices connected to base station 150 to access network components of private cellular network 100, devices of local network 170, external connections via private network gateway 160, etc., as well as to perform particular actions on private cellular network 100. In some examples, the modules of mobility core modules 120 can be modified to perform the functionality attributed to authorization module 182 herein and server 140 can lack authorization module 182. For example, one or more of UDM 180C, PCF 180D, SMF 180E, and UPF 180F can be modified to perform the functionality attributed to authorization module 182 herein. Authorization module 182 can include a network access control policy for limiting network endpoint access according to user identity or another suitable identifier for authorization and access control.

Onboarding module 190 is a software module of wireless device 120 and includes one or more programs for onboarding wireless device 120 to private cellular network 100. In particular, onboarding module 190 enables wireless device 120 to request a SIM configuration (i.e., SIM configuration 129) from SIM broker 156. Onboarding module 190 further enables wireless device 120 to install that SIM configuration to eSIM 128 and, subsequently, to self-onboard to local network 100. Onboarding module 190 can include one or more programs for authenticating to UWB network 110. For examples, onboarding module 190 can include one or more programs that store authentication information for authenticating wireless device 120 to access UWB network 110. The authentication information can be, for example, user identity information, including one or more of a username and password. In some examples, onboarding module 190 can also access device information for wireless device 120, such as the IMEI for wireless device 120, to provide that information to SIM broker 156 via UWB network 110. Additionally and/or alternatively, onboarding module 190 can be configured to provide user identity information, such as a username and/or password, to SIM broker 156.

SIM generation module 192 is a software module of SIM broker 156 and includes one or more programs for generating network profiles that can be used by wireless devices, such as wireless device 120, to connect to private cellular network 100. The program(s) of SIM generation module 192 can automatedly generate a new SIM configuration and/or retrieve a pre-generated SIM configuration (e.g., from memory 158, server 140, or another suitable database). SIM generation module 192 can also verify and/or authenticate user and/or device identity prior to providing a SIM configuration to a user device (e.g., wireless device 120). Wireless device 120 can send identity information (e.g., user identity information, device identity information, etc.) along with the request to join private cellular network 100. Additionally and/or alternatively, the programs of SIM generation module 192 can request identity information from wireless device 120 in response to receiving a request to join private cellular network 100. The programs of SIM generation module 192 can access one or more databases stored on memory 158, memory 144, or another device (i.e., another memory device or a device other than SIM broker 156 and server 140) to authenticate the device and/or user identity information.

While each of server 140, base station 150, SIM broker 156, and private network gateway 160 are depicted as separate components of private cellular network 100, in at least some examples, two or more of server 140, base station 150, SIM broker 156, and private network gateway 160 can be a single physical device. For example, server 140 and base station 150 can be instantiated on a single hardware device that performs the functions of both server 140 and base station 150 described herein. Further, in some examples, one or more of server 140, base station 150, SIM broker 156, and private network gateway 160 can be distributed (e.g., virtualized) across any suitable number of hardware devices.

SIM broker 156 is depicted as a component of private cellular network 100 in FIG. 1, but in other examples, SIM broker 156 is separate from private cellular network 100. As a specific example, SIM broker 156 can be, for example, a component of local network 170, a component of UWB network 110, or a network component separately accessible from any of private cellular network 100, UWB network 110, and local network 170. More generally, the boundaries of private cellular network 100 and local network 170 (indicated by dotted lines) as well as the boundaries of UWB network 110, which is depicted as a network separate from private cellular network 100 and local network 170, are depicted for explanatory purposes and, in other embodiments, each of the aforementioned components depicted in FIG. 1 can have any suitable physical and/or logical boundaries.

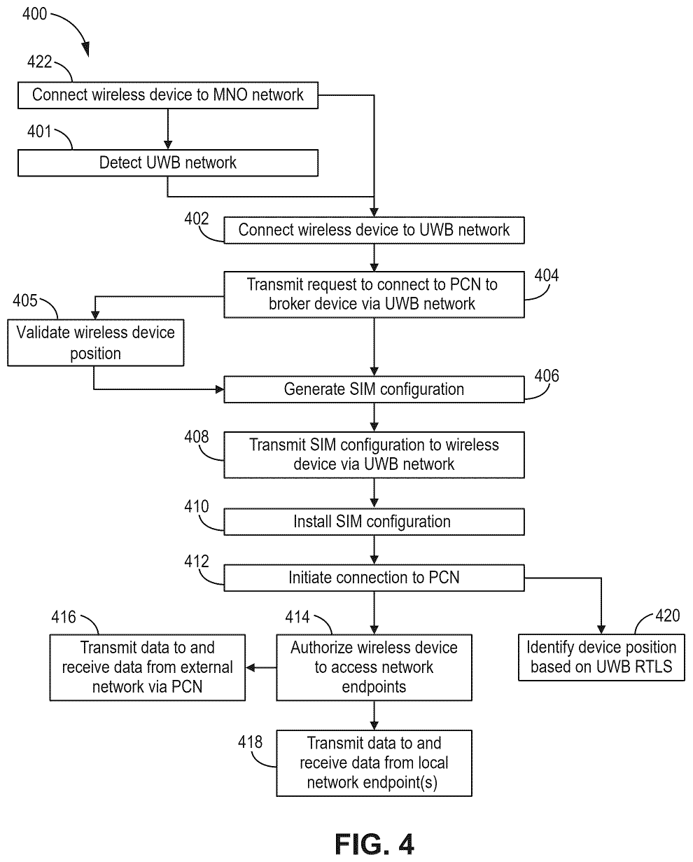

System 10 advantageously enables automated self-onboarding of wireless devices, as will be explained in more detail subsequently and particular with respect to the discussion of method 400 (FIG. 4), discussed subsequently. In particular, system 10 enables transmission of SIM configurations for self-onboarding of wireless devices via UWB network 110. Notably and as described elsewhere herein, the connection to UWB network 110 used for self-onboarding can also be used for RTLS positioning of wireless devices.

System 10 also enables a single user device (i.e., wireless device 120) to be used for communication with private cellular network 100, UWB network 110, and, optionally, an external MNO network. Conversely, using existing systems and methods, separate devices would be required to transmit data with private cellular network 100, to track user position using UWB network 110, and to transmit data with an MNO mobile network. In this manner, system 10 and methods of using system 10 for onboarding (e.g., method 400, discussed subsequently; FIG. 4) advantageously reduce the number of devices needed to be carried by users. Further, in applications where it is already desirable to track user position using a UWB network, system 10 and relevant methods of onboarding using system 10 (e.g., method 400; FIG. 4) enable guest onboarding using existing network infrastructure.

FIG. 2 is a schematic diagram of UWB network 210. UWB network 210 is one example of a UWB-based RTLS system and, further, is one example of a UWB network suitable for use as UWB network 110. UWB network includes UWB anchors 212A-D, wireless device 220, UWB signals 222A-222D, and RTLS server 230.

UWB anchors 212A-D are UWB base stations capable of transmitting and receiving UWB signals. UWB anchors 212A-D are communicatively connected to RTLS server 230. UWB anchors 212A-D can each include an antenna and one or more transceiver elements for transmitting and receiving UWB signals.

Wireless device 220 is a wireless device capable of sending and receiving UWB signals. In some examples, wireless device 220 can be or can be substantially similar to wireless device 120 (FIG. 1), as described previously.

UWB signals 222A-222D represent UWB transmissions between wireless device 220 and UWB anchors 212A-D, respectively. Wireless device 220 and UWB anchors 212A-D are each capable of sending and receiving UWB signals, and, further, UWB is capable of sending received signal information to RTLS server 230 to perform positioning estimations of wireless device 220.

RTLS server 230 is a network component or network device of UWB network 210 and includes one or more software programs for estimating the position of wireless device 220 based on UWB transmissions communicated between wireless device 220 and UWB anchors 212A-D. RTLS server 230 controls the operation of UWB anchors 212A-D to enable UWB network 210 to perform positioning of wireless device 220 using any suitable RTLS method. In at least some examples, position estimation of wireless device 220 is performed using a time difference of arrival (TDoA) or two way ranging (TWR) technique.

UWB network 210 is a simplified example of a UWB network for explanatory clarity and, in other examples, a UWB RTLS system according to the present disclosure can have any suitable number of anchor points, can determine the position of any suitable number of UWB-capable wireless devices, and can include any other suitable number of network components. Further, four anchor points are depicted in FIG. 2 for explanatory clarity. In other examples, UWB network 210 can include fewer than four UWB anchor points (e.g., three UWB anchor points) or more than four UWB anchor points. UWB anchors used for RTLS positioning are generally placed in sufficiently geographically close proximity to enable wireless device 120 to communicate with multiple UWB anchors simultaneously pursuant to a, e.g., TDoA or TWR positioning technique.

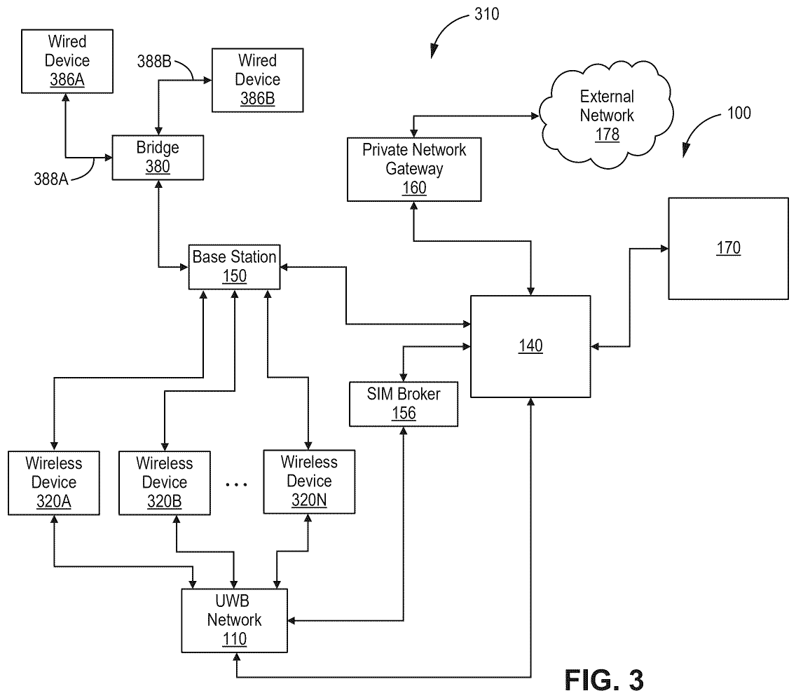

FIG. 3 is a schematic diagram of system 310, which is another example of a system for automated device onboarding to a private cellular network. System 310 is substantially similar to system 10 and includes private cellular network 100 and UWB network 110. Private cellular network 100 includes server 140, base station 150, SIM broker 156, private network gateway 160 FIG. 3 also depicts local network 170 and external network 178. However, system 310 includes three wireless devices 320A-N instead of the single wireless device 120 of system 10 (FIG. 1). System 310 also includes bridge 380, wired devices 386A-B, and non-cellular connections 388A-B.

Each of wireless devices 320A-N are connected to both UWB network 110 and base station 150 of private cellular network 100. Further, each of wireless devices 320A-N is substantially similar to wireless device 120 of system 10 (FIG. 1), and the description of wireless device 120 herein is applicable to each of wireless devices 320A-N.

System 310 is one example of a system in which multiple wireless devices are connected to both private cellular network 100 and UWB network 110. The automated onboarding described subsequently herein (and particular with respect to FIG. 4) can be performed for each of wireless devices 320A-N simultaneously, substantially simultaneously, in a partially temporally overlapping manner, sequentially, etc.

System 310 is merely one illustrative example of a system include multiple wireless devices and other examples are contemplated herein. To that extent, while system 310 is depicted as including only three wireless devices 320A-N, in other examples, system 310 can include any suitable number of wireless devices, including fewer than three (e.g., two) or greater than three wireless devices.

System 310 also optionally includes bridge 380, which is capable of connecting to private cellular network 100 and, further, of providing connectivity to non-cellular devices 386A-B via non-cellular connections 388A-B. Bridge 380 is a wireless device for enabling devices lacking cellular transceivers to access private cellular network 100. Bridge 380 includes a pre-programmed or programmable SIM as well as a cellular transceiver for connecting to private cellular network 100. further, can include one or more hardware ports or connectors for connecting non-cellular devices. Additionally and/or alternatively, bridge 380 can communicate wirelessly with non-cellular devices via a network broadcast by bridge 380, thereby enabling non-cellular devices to access private cellular network 100 and, optionally, local network 170 and/or external network 178 via private cellular network 100.

Bridge 380 is configured to receive electronic signals from wired devices connected to bridge 184 and to relay or convert and subsequently transmit the data or information represented by those electronic signals to base station 150 of private cellular network 100 as electromagnetic signals. Bridge 184 can include one or more processors, memories, and interfaces that are substantially similar to processor 142, memory 144, and interface 146, respectively.

Non-cellular devices 386A-B are devices that lack cellular transceivers and are connected to bridge 380 by non-cellular connections 388A-B, respectively. Non-cellular devices 386A-B each include a processor and a memory that are substantially similar to processors 122, 142 and memories 124, 144, respectively, and, in some examples, can include an interface (e.g., a user interface) that is substantially similar to interfaces 126, 146. Each of non-cellular devices 386A-B can be, for example, a desktop computer, a laptop computer, an internet of things (IoT) device, a robotic device, or any other suitable hardware device. The IoT device can be, for example, a welder, a coffee maker, a refrigerator, a television, etc. Non-cellular connections 388A-B can each be a wired or wireless connection. The depicted example of system 310 includes two non-cellular devices 386A-B connected to one bridge 380 for explanatory clarity and convenience. In other examples, system 10 can include any number of bridge devices each connected to any number of non-cellular devices.

Bridge 380 is not connected to UWB network 110 in the embodiment of system 310 depicted in FIG. 3. Bridge 380 does not require RTLS-based positioning as the location of bridge 380 is likely to be generally unchanging. However, in other examples, bridge 380 can be connected to UWB network 110 to, for example, use UWB network 110 for onboarding of bridge 380 to private cellular network 100.

FIG. 4 is a flow diagram of method 400, which is a method of automatedly onboarding a wireless device to a mobile wireless network. As will be explained in more detail subsequently, method 400 uses a UWB network to transmit SIM configurations to wireless devices. Method 400 optionally includes steps for transmitting data to and receiving data from the device as well as for locating the device using the UWB network used to transmit the SIM configuration. Method 400 includes steps 401-422 of detecting a UWB network (step 401), connecting a wireless device to the UWB network (step 402), transmitting a request to connect to a private cellular network to a broker device via the UWB network (step 404), generating a SIM configuration (step 406), transmitting the SIM configuration to a wireless device via the UWB network (step 408), installing the SIM configuration (step 410), initiating a connection to the private cellular network (step 412), authorizing the wireless device to access network endpoints (step 414), transmitting data to and receiving data from an external network via the private cellular network (step 416), transmitting data to and receiving data from at least one local network endpoint (step 418), identifying the position of the wireless device based on UWB RTLS (step 420), and connecting the wireless device to an MNO network (step 422). Method 400 is generally described herein with reference to system 10 (FIG. 1), but method 400 can be used by any suitable system to perform automated onboarding of wireless devices to a private cellular network.

In step 401, the wireless device detects a UWB network. Step 401 is an optional step of method 400, but advantageously enables wireless devices 400 entering the broadcast area of UWB network 110 to automatedly sense and attempt to connect to UWB network 110 without requiring user input to wireless device 120, such as scanning of a quick-response (QR) code. In some examples, step 401 can be performed automatically (i.e., without need for any user intervention) by wireless device 120 when wireless device 120 enters the broadcast area of UWB network 110. Wireless device 120 can be configured to periodically and/or continuously scan for UWB signals.

In step 402, the wireless device connects to the UWB network. Wireless device 120 connects to UWB network 110. If UWB network 110 requires users to authenticate to UWB network 110 prior to connecting, an application of user device 120 can prompt the user to provide authentication information. In some examples, authentication information can be pre-registered on wireless device 120 by the user (i.e., before performance of step 402), and that authentication information can be retrieved by wireless device 120 in an automated manner and/or in response to one or more user inputs (e.g., pressing a button of a user interface). The authentication information can be, for example, username information and/or password information. In some examples, authentication to UWB network 110 can be performed by scanning a QR code located within the range of a base station of UWB network a camera of wireless device 120.

In examples of method 400 including step 401, step 402 can be performed responsively to the detection of the wireless network in step 401. In other examples, wireless device 120 can discover UWB network 110 manually by, for example, scanning a QR code located within the range of a base station of UWB network 110 using a camera of wireless device 120.

In step 404, the wireless device transmits a request to connect to a private cellular network via the UWB network the wireless device was connected to in step 402. Specifically, wireless device 120 transmits the request to the base station or anchor of UWB network 110 to which wireless device 120 was connected in step 402. An application of onboarding module 190 or another suitable software element of wireless device 120 can communicate a request to broker device 156 via the connection to UWB network 110. Private cellular network 100 and UWB network 110 are configured such that wireless device 120 is within range of a base station of private cellular network 100 while connected to the base station of UWB network 110 (i.e., the base station to which the request is transmitted).

The request can optionally include various identifying information that broker device 156 can use to authenticate wireless device 120 prior to generation of the SIM configuration. These examples advantageously enable control of access to private cellular network 110. In these examples, the information used for authentication can be information identifying wireless device 120 and/or information identifying the user of wireless device 120 (i.e., user 199). The user identifying information can be, for example, login information, such as username and/or password information. The device identifying information can be, for example, an IMEI for wireless device 120. The request can also include additional information describing wireless device 120, such as the operating system of wireless device 120 and/or whether wireless device 120 is configured to operate using a particular telecommunication standard (e.g., a 5G standard, an LTE standard, etc.), among other options.

In step 405, the position of wireless device 120 is validated. Step 405 is an optional step of method 400 and is included in examples where it is desirable to verify that wireless device 120 is within the geographic extent of UWB network 110. Positioning unit 135 determines an approximate position of wireless device 120 based on received geopositioning signals and can provide that information with the request sent in step 404. SIM broker 156 and/or server 140 can validate the position of wireless device 120 as within the broadcast area of UWB 110 prior to proceeding to step 406. Step 405 functions as a validation that wireless device 120 is actually within the broadcast range of UWB network 110 and, accordingly, also functions to screen devices erroneously detected as connected to an access point of UWB network 110.

In step 406, SIM broker 156 generates a SIM configuration for wireless device 120. SIM broker 156 can generate SIM configuration 129 by creating a new SIM configuration and/or by selecting a pre-configured or pre-generated SIM configuration (i.e., from a database or another suitable repository). SIM configuration 129 can be based and/or selected according to identifying information and/or the additional descriptive information of wireless device 120 (e.g., the operating system of wireless device 120) transmitted with the request in step 404. SIM broker 156 can also modify data of server 140 that is managed by and/or access by mobility core modules 120 to enable the new SIM configuration (i.e., SIM configuration 129) to be used to authenticate wireless device 120 to private cellular network 100. In some examples, the process of modifying data of server 140 can be referred to as “activating” the new SIM configuration for use with private cellular network 100.

SIM broker 156 can optionally use identifying information included in the request transmitted in step 404 to authenticate wireless device 120 and/or user 199 as a valid requesting entity. In these examples SIM broker 156 can validate the identity of wireless device 120 and/or user 199 using an internal database (i.e., stored to memory 158) and/or to a database connected to SIM broker 156.

In step 408, SIM configuration 129 generated in step 406 is transmitted to wireless device 120 via UWB network 110. SIM broker 156 can transmit SIM configuration 129 to UWB network 110, and a base station of UWB network 110 can transmit SIM configuration 129 wirelessly to wireless device 120.

In step 410, SIM configuration 129 is installed to eSIM 128 of wireless device 120. In step 410, SIM configuration 129 is provided to eSIM 128 and can be stored to a storage device of eSIM 128 for use in subsequent step 412 and, more generally, to authenticate wireless device 120 to private cellular network 100.

In step 412, wireless device 120 initiates a connection to private cellular network 100. In step 412, wireless device 120 authenticates to private cellular network 100 for the first time. If the SIM configuration generated in step 406 was not activated in step 406, SIM configuration 129 can be activated for use in step 412 to enable wireless device 120 to connect to private cellular network 100.

In some examples, additional authorization is required to access external network 178 or another external network that is accessible via private cellular network 100. In these examples, authorization of wireless device 120 can be performed by authorization module 182 of server 100. Authorization can be performed using any suitable credential(s) and can be performed in the manner described subsequently with respect to step 416.

In step 414, wireless device 120 is authorized to access endpoints of local network 170 and/or private cellular network 100. The endpoints can include, for example, one or more of external network 178 (via private network gateway 160), one or more local devices 172A-172N of local network 170, and any other suitable endpoint of private cellular network 100.

Wireless device 120 can transmit one or more authorization credentials via UWB network 110 and/or private cellular network 100, such as username and/or password information, to server 100 and authorization module 182 can authorize wireless device 120 to access network endpoints based on the transmitted authorization credentials. In at least some examples, step 416 is performed concomitantly or substantially concomitantly with step 404 and/or step 406, such that access control for private cellular network 100 and authorization for network endpoint access are performed at the same time or substantially the same time. In at least some examples, authorization in step 416 can be performed using the identifying information received in step 404.

In some examples, SIM configuration 129 of wireless device 120 can also be used to authorize the device and to control access to network components of the wireless network. For example, private cellular network 100 may be configured to enable pass-through access to an external network (e.g., guest Internet access) without credentials and, further, to solicit input from a user in step 402 as to whether the user would like to access an external network and/or any local network components. Based on the user's input in response to the solicitation (i.e., by authorization module 182), the user can be authorized to one or more network endpoints, e.g., by authorizing the user with the identity information used for SIM configuration generation. In these examples, the SIM configuration generated in step 406 can be flagged, labeled, tagged, etc. in a database, table, etc. maintained by SIM broker 156 or another network device of private cellular network 100 (e.g., server 140) accordingly, and that database, table, etc. can be used for access control by private cellular network 100. Additionally and/or alternatively, the SIM configuration generated in step 406 can assign the wireless device to a particular network slice that only includes devices to which the wireless device is authorized to access. In these examples, step 414 can be performed prior to step 406 and/or as part of step 404, and method 400 can proceed directly to step 416 and/or step 418 after step 412.

Any of the foregoing methods of authorization can be combined to control access to different network components. For example, SIM configuration 129 generated in step 406 can be used to authorize access to external network 178 and user-provided credential information can be used to authorize access to local network 170 components. Other possibilities and combinations are possible and the foregoing examples are non-limiting and are merely illustrative.

Step 414 is an optional step of method 400 and is performed in examples where it is desirable to enable controlled access of network endpoints to devices connected to private cellular network 100. In examples of method 400 lacking step 414, method 400 can progress from step 412 to step 416 and/or step 418.

In step 416, wireless device 120 transmits data to and receives data from an external network via private cellular network 100. Step 414 is an optional step of method 400 and can included in examples where private cellular network 100 is configured to enable access to an external network, such as the Internet. Wireless device 120 can send data to and/or receive data from external network 178 via private network gateway 160 or any other suitable external network connected to private cellular network 100 (via private network gateway 160 or any other suitable gateway device). In examples where external network 178 is or includes the Internet, wireless device 120 can access any desired Internet address via private cellular network 100.

In step 418, wireless device 120 transmits data to and receives data from one or more local network endpoints to which wireless device 120 was authorized to access in step 416. The local network endpoints can be, for example, any of local devices 172A-172N of local network 170 and/or any other suitable local network endpoint of private cellular network 100 and/or local network 170. For example, one of local devices 172A-172N could be a local server or file repository to which user 199 of wireless device 120 is authorized to access.

In step 420, the position of wireless device 120 is identified using an RTLS service of UWB network 110. UWB network 110 can perform any suitable RTLS method for locating the position of wireless device 120, including a TDoA or TWR method, as described previously with respect to the discussion of UWB network 210 (FIG. 2). Step 420 is an optional step of method 400 and is included in examples where it is advantageous to track the position of wireless device 120.

In step 422, wireless device 120 connects to an MNO network using SIM configuration 131 of SIM 130. Step 422 is an optional step of method 400 and is performed in examples of method 400 in which wireless device 120 also includes SIM 130 and SIM configuration 131. Step 422 can be performed at any point before step 401 and/or at any other suitable point of method 400 (e.g., during any of 401-420). Step 422 also connects wireless device 120 to an MNO network, thereby enabling voice calls, data transmission, etc. via the MNO network. In examples of method 400 lacking step 401 and including step 422, method 400 proceeds to step 402 from step 422. In examples of method 400 including both step 401 and step 422, method 400 proceeds to step 401 following step 422.

Advantageously, method 400 enables automated onboarding of wireless devices to a private cellular network using a connected UWB network. The UWB network can subsequently be used to locate the wireless device while the private cellular network can be used for data transmission to external networks, local endpoints, etc. As described previously, private cellular networks can be used to provide internet access in a variety of locations in which other wireless technologies, such as Wi-Fi. Private cellular networks also have enhanced range as compared to shorter range wireless technologies (e.g., Wi-Fi) and, as such, require fewer base stations to provide an equivalent area of service. Certain business environments, such as large manufacturing environments, academic campuses, hospital campuses, etc., can achieve significant coverage improvements for guest internet access by using private cellular networks rather than existing solutions reliant on shorter range networks.

As described previously, existing solutions do not provide for automated, on-site onboarding to private cellular networks, and thereby require significant time and pre-planning to onboard user equipment prior to use. Advantageously, method 400 allows devices to automatedly self-onboard to a private cellular network while the user equipment to be onboarded is on-site and without manual intervention by a technician or other skilled operator. Further, method 400 enables devices to self-onboard to a wireless network with minimal involvement from a user (e.g., as few as one user interface interaction) and, optionally, without any direct user interaction.

In at least some examples, steps 401-412 occur in a fully automated manner and without user input. When wireless device 120 enters into geographic proximity of a beacon of UWB network 110 (e.g., when brought into geographic proximity of such a beacon by a user), wireless device 120 automatedly and reactively detects and connects to UWB network 110 (i.e. steps 402-404). In response to wireless device 120 connecting to UWB network 110, server 110 and/or SIM broker 156 automatedly configure and push an eSIM profile to wireless device 120 (i.e., steps 406-410). As described previously, server 110 and/or SIM broker 156 can automatedly determine whether wireless device 120 should connect to private cellular network 100 (e.g., via one or more authentication steps using information harvested from wireless device 120) before issuing the eSIM profile. Wireless device 120 can then automatedly activate the eSIM profile and connect to private cellular network 100 (i.e., step 412). In such examples, the only action required of the user can be to bring wireless device 120 within range of a beacon of UWB network 110. Each of steps 401-412 can occur automatically and immediately in response to performance of the prior step. Further, in some examples, step 401 can be performed automatically when a user brings wireless device 120 within range of a beacon of UWB network 110, such that wireless device 120 is onboarded to private cellular network 100 automatically and without user input upon wireless device entering the broadcast area of UWB network 110. In examples of method 400 including optional step 405, the position of wireless device 120 can also be automatedly collected and subsequently validated as within the geographic extent of UWB network 110 before server 110 and/or SIM broker 156 configure and push the eSIM configuration.

Additionally, the self-onboarding provided by method 400 does not require connecting devices to be managed devices (e.g., subject to mobile device management policies and software), and, as such, can be used to provide guest Internet access to visitors (i.e., having unmanaged devices) of a business, facility (e.g., a medical or manufacturing facility), or any other suitable physical location at which a private cellular network is located.

One notable application of method 400 is providing Internet access and RTLS services for construction jobsites. Private cellular networks advantageously provide service to a relatively large area with a relatively low number of base stations. Further, embodiments of method 400 including step 420 enable automated tracking of worker wireless devices throughout the construction jobsite using the same UWB network used for onboarding (i.e., UWB network 110 in system 10; FIG. 1). As worker wireless device position can be presumed to be relatively synonymous with worker position, tracking worker device position can provide real-time information about worker position. Worker position information can be used to detect, for example, whether a worker enters a restricted (e.g., dangerous) area, whether a worker is working in the correct location, and/or how long the worker spent at a particular location (and, by proxy, on a particular task), among other options. If a worker enters a restricted area, the mobile device carried by the worker can emit a sound, vibrate, etc. to notify the worker that the worker is in a restricted area and/or to leave the restricted area. If the worker is working in an incorrect location, server 100 can note that the worker is in the incorrect location and that a fixture or other item installed by the worker may be in the wrong location. Additionally and/or alternatively, the wireless device can notify the worker that the worker is in the incorrect location. The amount of time the worker spends in a particular location can be used to infer how long a worker has spent on a particular task, and that information can be stored to server 100 or another suitable device to evaluate worker efficiency, among other options.

Other options for tracking data are contemplated herein and the foregoing description contains exemplary options for illustrative purposes. Further, method 400 can be adapted to confer advantages contemplated herein to a wide variety of locations and the foregoing example of a construction jobsite is merely one example of a location to which method 400 can be adapted.

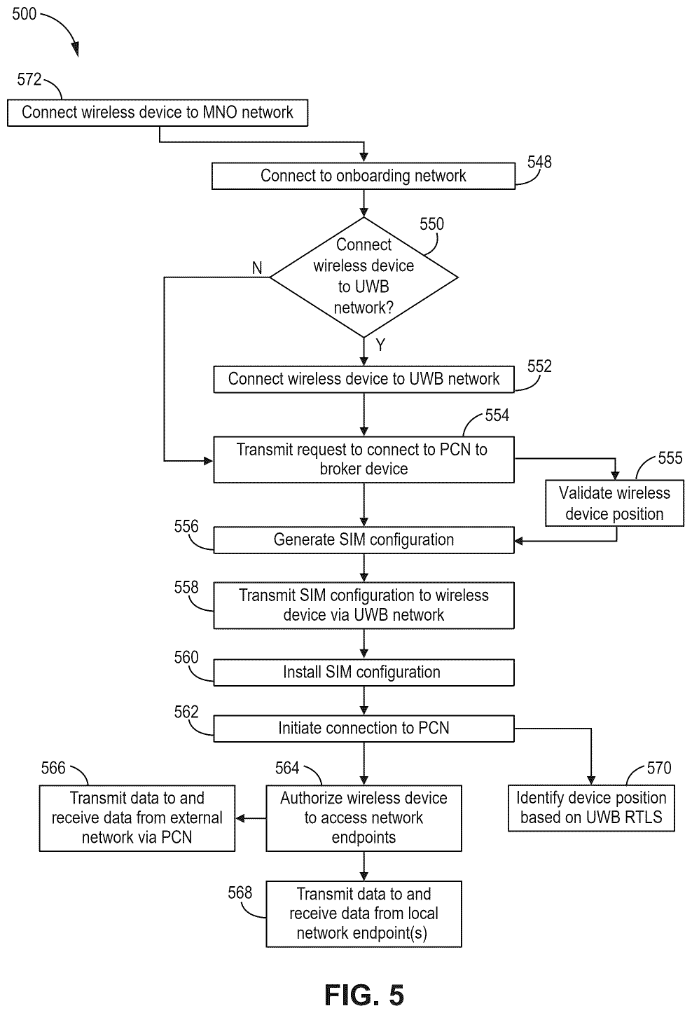

FIG. 5 is a flow diagram of method 500, which is another method of automated self-onboarding of wireless devices to a private cellular network. Method 500 is substantially similar to method 400, but enables the use of a third network (i.e., other than an ultra-wideband network and a private cellular network) for onboarding wireless devices. Method 500 includes steps 548-572 of connecting a wireless device to an onboarding network (step 548), connecting the determining whether to connect the wireless device to the UWB network (step 550), connecting the wireless device to the UWB network (step 552), transmitting a request to connect to a private cellular network to a broker device via the UWB network (step 554), validating a wireless device position (step 555), generating a SIM configuration (step 556), transmitting the SIM configuration to a wireless device via the UWB network (step 558), installing the SIM configuration (step 560), initiating a connection to the private cellular network (step 562), authorizing the wireless device to access network endpoints (step 564), transmitting data to and receiving data from an external network via the private cellular network (step 566), transmitting data to and receiving data from at least one local network endpoint (step 568), and identifying the position of the wireless device based on UWB RTLS. Method 500 is generally described herein with reference to system 10 (FIG. 1), but method 500 more generally can be used by any suitable system to automatedly onboard wireless devices to a private cellular network.

In step 548, a wireless device connects to an onboarding network. The onboarding network can be, for example, a segment of UWB network 110. Additionally and/or alternatively, the onboarding network can be a different, third wireless network, such as a short-range Wi-Fi network connected to one or more of SIM broker 156, server 140, and UWB network 110.

Once wireless device 120 is connected to the onboarding network, an application of wireless device 120 can then initiate the process of connecting wireless device 120 to UWB network 110 and/or private cellular network 100 via subsequent steps 550-562.

In step 550, the onboarding application(s) of wireless device 120 determine whether to automatically connect wireless device 120 to UWB network 110. The onboarding application(s) can accept one or more user inputs determining whether to connect to UWB network 110 and/or can automatically determine whether to connect to UWB network 110 based on one or more save user preferences.

If the wireless device 120 should be connected to UWB network 110, method 500 proceeds to step 552. If the wireless device should not be connected to UWB network 110 and should only be connected to private cellular network 100, method 500 proceeds to step 554.

In some examples, the onboarding application(s) can also prompt the user to whether the user would like to connect to private cellular network 110 and/or retrieve one or more user preferences to determine if wireless device 120 should connect to private cellular network. If, according to user input, user preference data, etc., the onboarding application(s) determines that wireless device 120 should not connect private cellular network 100, method 500 does not progress to step 554 and, according to the decision made in step 500, method 500 stops after step 500 or after step 552.

In step 552, wireless device 120 connects to UWB network 110. Step 552 is substantially similar to step 402, except that wireless device 120 discovers UWB network 110 using the onboarding network connected to in step 548. Wireless device 120 can then connect to UWB network 110 using, for example, one or more access credentials, etc., as discussed previously.

In step 554, wireless device 120 transmits a request to connect to private cellular network 100 to SIM broker 156. Step 554 is substantially similar to step 404 of method 400, except that the request can optionally be transmitted via the onboarding network or the UWB network connected to in step 552.

In step 555, the position of wireless device 120 is validated. Step 555 is substantially similar to step 405 of method 400, except that the position is validated relative to the expected position of the onboarding network connected to in step 548.

Steps 556, 558, 560, 562, 564, 566, 568, 570, and 572 are substantially similar to steps 406, 408, 410, 412, 414, 416, 418, 420, and 422 of method 400 (FIG. 4), respectively, and the description of steps 406, 408, 410, 412, 414, 416, 418, 420, and 422 of method 400 is applicable to steps 556, 558, 560, 562, 564, 566, 568, 570, and 572 of method 500, respectively.

Method 500 offers substantially the same advantages as method 500, but embodiments of method 500 where the onboarding network is Wi-Fi or another, third network type enable devices unable to discover ultra-wideband networks to be automatedly onboarded to a private cellular network. Method 500 also enables a guest segment of an ultra-wideband network to be used for onboarding, thereby enabling greater control over the portion of the ultra-wideband network to which unauthenticated devices connect for onboarding.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the present disclosure.

1. A method of onboarding devices to a private cellular network, the method comprising:
receiving, by an ultra-wideband base station, device identity information for a user device to be connected to the private cellular network;
receiving, by the ultra-wideband base station, a request from the user device to connect to the private cellular network;
transmitting, by the ultra-wideband base station, the request to a subscriber identity module (SIM) broker;
generating, by the SIM broker, a new electronic subscriber identity module (eSIM) configuration for the user device based on the device identity information;
transmitting, by the SIM broker, the new eSIM configuration to the ultra-wideband base station;
transmitting, by the ultra-wideband base station, the new eSIM configuration to the user device;
installing, by the user device, the eSIM configuration to an eSIM of the user device; and
initiating, by the user device, a connection between the user device and the private cellular network using the installed eSIM configuration.

2. The method of claim 1, and further comprising, prior to receiving the device identity information and the request to connect to the private cellular network:
moving the wireless device to a position within a broadcast area of the ultra-wideband base station;
upon moving the wireless device to the position, detecting, by the user device, radio signals emitted from the ultra-wideband base station;
in immediate response to detecting the radio signals from the ultra-wideband base station, connecting the user device to the ultra-wideband base station;
transmitting, after connecting to the ultra-wideband base station and by the user device, to the device identity information and the request to the ultra-wideband base station.

3. The method of claim 2, wherein each of detecting the radio signals, connecting to the ultra-wideband base station, transmitting the device identity information and the request, installing the eSIM configuration, and initiating the connection are performed without user input to the user device.

4. The method of claim 3, wherein each of receiving the device identity information, receiving the request, transmitting the request to the SIM broker, generating the new eSIM configuration, transmitting the new eSIM configuration to the ultra-wideband base station, and transmitting the new eSIM configuration to the user device are performed without user input.

5. The method of claim 1, wherein the base station receiving the device identity information is physically proximate to a base station of the private cellular network.

6. The method of claim 1, wherein establishing the connection between the user device and the private cellular network comprises authenticating, by a server of the private cellular network, the eSIM configuration.

7. The method of claim 6, and further comprising, prior to generating the new eSIM configuration:
collecting a position of the user device using a positioning unit of the user device; and
validating that the position of the user device is within a broadcast area of the ultra-wideband base station.

8. The method of claim 7, and further comprising:
receiving, by a ultra-wideband base station, a request from the user device to connect to the private cellular network;
transmitting, by the ultra-wideband base station, the request to a SIM broker; and
requesting, by the SIM broker, the device identity information in response to receiving the request.

9. The method of claim 8, wherein the device identity information is IMEI information.

10. The method of claim 8, and further comprising:
receiving, by the ultra-wideband base station, user identity information; and
transmitting, by the ultra-wideband base station, the request to the SIM broker;
wherein generating the new eSIM configuration comprises generating the new eSIM configuration based on the device identity information and the user identity information.

11. The method of claim 10, and further comprising:
detecting, by the user device, radio signals emitted by the ultra-wideband base station; and
responsive to detecting the radio signals, transmitting the request to connect to the private cellular network.

12. The method of claim 11, wherein the ultra-wideband base station is one base station of a plurality of base stations of an ultra-wideband network, and further comprising collecting location period during a first time period based on radio signals sent by base stations of the plurality of base stations and the user device.

13. The method of claim 12, wherein the plurality of base stations broadcast the ultra-wideband network to an area that is at least partially overlapping with the private cellular network.

14. The method of claim 13, and further comprising accessing, by the user device, at least one of a local resource and an internet-accessible resource via the connection between the user device and private cellular network.

15. The method of claim 14, wherein:
the eSIM of the user device is a first SIM of the user device, and
the user device includes a second SIM having a second SIM configuration for accessing a cellular network operated by mobile network operator (MNO) network.

16. The method of claim 15, and further comprising establishing a connection between the user device and the MNO network using the second SIM configuration.

17. A method of self-onboarding of a wireless device to a private cellular network, the method comprising:
detecting an ultra-wideband base station of an ultra-wideband network, the ultra-wideband network connected to a SIM broker;
in response to detecting the ultra-wideband base station, connecting the wireless device to the ultra-wideband base station;
in response to detecting the ultra-wideband base station, transmitting, by the wireless device, a request to connect to a private cellular network to the ultra-wideband base station, wherein a destination of the request is the SIM broker;
receiving, from the ultra-wideband base station, a SIM configuration generated by the SIM broker;
installing the SIM configuration to an eSIM of the wireless device; and
establishing a connection between the wireless device and the private cellular network using the installed eSIM configuration.

18. The method of claim 17, wherein:
the eSIM of the user device is a first SIM of the user device, and
the user device includes a second SIM having a second SIM configuration for accessing a cellular network operated by mobile network operator (MNO) network.

19. A system for automated device onboarding to a private cellular network, the system comprising:
a base station of an ultra-wideband network;
a base station of the private cellular network;
a SIM broker comprising a first processor and at least one first memory, the at least one first memory encoded with first instructions that, when executed, cause the first processor to:
receive a request to connect to the private cellular network; and
generate a SIM configuration in response to the request; and
a wireless device comprising an electronic subscriber identity module (eSIM), a second processor, and at least one second memory, the at least one second memory encoded with second instructions that, when executed, cause the second processor to:
establish a first connection with the base station of the ultra-wideband connection;
transmit the request to connect to the private cellular network to the ultra-wideband network, wherein a destination of the request is the SIM broker;
receive the SIM configuration from the SIM broker via the first connection;
install the SIM configuration to the eSIM; and
establish a second connection with the base station of the private cellular network using the installed SIM configuration.

20. The system of claim 19, wherein:
the second instructions, when executed, cause the wireless device to transmit identifying information with the request; and
the first instructions, when executed:
cause the SIM broker to authenticate the wireless device using the identifying information before generating the SIM configuration; and
generate the SIM configuration in response to authenticating the wireless device.
